(19) United States
(12) Patent Application Publication
(10) Pub. No.: US 2010/0229784 A1
(43) Pub. Date: Sep. 16, 2010

(54) BLAST OCCURRENCE APPARATUS

(75) Inventors: Timothy D. Bayne, Nepean (CA); Nicholas Shewchenko, Greely (CA)

Correspondence Address: FAEGRE & BENSON LLP;PATENT DOCKETING - INTELLECTUAL PROPERTY, 2200 WELLS FARGO CENTER, 90 SOUTH SEVENTH STREET, MINNEAPOLIS, MN, 55402-3901, US

(73) Assignee: Biokinetics and Associates Ltd., Ottawa (CA)

(21) Appl. No.: 12/390,935

(22) Filed: Feb. 23, 2009

Related U.S. Application Data
(60) Provisional application No. 61/030,278, filed on Feb. 21, 2008.

(51) Int. Cl. G01L 5/14

(52) U.S. Cl. 116/203

(57) ABSTRACT

There is provided a blast occurrence apparatus for indicating the occurrence of a significant and potentially injury causing blast overpressure. The apparatus comprises a base, a housing and blast indication means to provide a visual indication that a significant blast has occurred. A blast indication means may be implemented using a rupturable membrane or a layer of microencapsulated paint or dye material, dimensioned to rupture at the desired overpressure level. The device is configured to withstand acceleration or shock resulting from impact.

### RELATED APPLICATION

This application claims the benefit under Title 35, U.S.C., S.119(e) of U.S. Provisional Application No. 61/030,278 filed on Feb. 21, 2008, which is herein incorporated by reference.

### FIELD OF THE INVENTION

The present invention relates to a blast occurrence apparatus for detecting and providing an indication of the occurrence of a blast event.

### BACKGROUND OF THE INVENTION

In a battlefield environment, serious head and torso injuries may result from blasts due to improvised explosive devices (IEDs), rocket propelled grenades (RPGs), mortars and weapon's fire. These events result in damaging, high energy impulse shockwaves known as blast overpressures (BOP). In such an environment, it is often difficult to tell whether an individual has been exposed to a blast and has experienced an injury, such as a head injury or traumatic brain injury as a result of a BOP. Injured individuals may be unresponsive and unable to indicate the nature of their injuries. Alternatively, other individuals may not be aware they have sustained a potentially harmful blast level and may not seek proper medical attention. Thus, there is a need for a device which can quickly alert the individual or medical personnel that a potentially harmful blast level has occurred. Further, in the rugged environment of a battlefield, such indication of a blast having occurred must be simple, instantaneous, easy to read and provided without requiring additional power sources or complicated circuitry and external monitoring devices.

Devices for monitoring or measuring the occurrence of an impact or change in air pressure are known in the field. These include devices for monitoring the impact sustained by a sports helmet, such as U.S. Pat. No. 6,301,718 to Rigal, issued Oct. 16, 2001 and U.S. patent application, publication No. 2007/0089480 to Beck, published Apr. 26, 2007. Rigal discloses an impact sensing device for mounting on or in the shell of a sports helmet which indicates when the helmet has sustained a large impact, such that the impact performance of the helmet is comprised. The device of Rigal comprises a drop of a coloured liquid disposed between two gas bubbles whereby upon a violent impact, local acceleration of the liquid bubble breaks the surface tension at the surface of the liquid/gas interface. The colored liquid fills the device to indicate an impact of a predetermined level has occurred. Rigal further discloses a four “armed” device, with a liquid bubble disposed between four gaseous bubbles being more sensitive to multidirectional impacts. As well, Rigal discusses the use of two or more monitoring devices, placed in various positions of the cap.

Beck also discloses an impact monitoring device for use in sports and military helmets to detect a shock due to impact or blasts. The device may be based on the acceleration of a coloured liquid droplet in a light permeable container or may use an electronic accelerometer. In Beck, the detection of a blast event is approximated by the acceleration of the device; the device is placed on the back of the helmet in order for it to be exposed to the maximum acceleration on the wearer's head. Thus, blast detection and monitoring is provided only to the extent the blast simulates an impact or acceleration event resulting in movement of the helmet.

U.S. Pat. No. 5,621,922 to Rush III, issued Apr. 22, 1997 discloses a device for detecting rotational and linear forces on a helmet including electrically-powered accelerometers and electrical output(s) connected to an LED for indicating a threshold force has been detected. European patent application, publication No. EP1774252 to Van Albert also provides a complicated detection system to determine when a body has suffered an impact from a bullet or blast wave by sensing vibrations and converting these to electric signals.

As well, there are devices in the prior art for detecting the force or reach of a blast. U.S. Pat. No. 5,918,262 to Sanford, issued Jun. 29, 1999, discloses the use of frangible glass microspheres which are sized to shatter in response to a shock wave. The microspheres may be placed on a substrate whereby the geographic reach of a blast may be determined and mapped according to the patterned shattering of microspheres. Sanford discloses measuring peak pressures at 100 to 15,000 psi.

A number of devices are used in static industrial environments to respond to an increase in air or fluid pressure and to provide warnings, relief or process changes in response to such conditions. For example, U.S. Pat. No. 4,404,982 to Ou, issued Sep. 20, 1983 provides a disc apparatus designed to rupture at a predetermined fluid pressure. U.S. Pat. No. 4,612,739 to Wilson, issued Sep. 23, 1986, provides a venting panel which bursts at low positive or negative pressures. Many of these devices are directed to the proper rupture of a membrane so as to relieve pressure in a system, allowing the desired flow of fluids or gases and retaining the membrane so as to not break away from the device and enter the process itself.

These devices, however, are not suitable for the rugged environment of a battlefield, for temperature and altitude changes or for detection of a blast sufficient to harm a person.

Thus, there is a need to provide a blast occurrence apparatus which is sensitive to blast levels capable of causing human injury and which provides an immediate indication of such a blast without complicated circuitry or analysis. There is also a need to provide a blast occurrence apparatus which may operate in a dynamic environment, under harsh conditions and which is not triggered by impacts or ambient noises in a military environment.

### SUMMARY OF THE INVENTION

Embodiments of the present invention provide a blast occurrence apparatus for use in dynamic environments to provide an indication of a potentially harmful blast event as evidenced by a change in air pressure. According to an embodiment of the present invention, there is provided an apparatus for visually indicating a blast occurrence. The apparatus comprises a base, having an upper side and a lower side; a middle layer, vertically spaced from and attachable to the upper side of the base, the middle layer having at least one opening to ambient air; and blast indication means, attachable to the middle layer. The blast indication means provides a visual indication of the blast occurrence at or above a predetermined blast pressure and impulse experienced by the apparatus.

According to a further embodiment of the present invention there is provided an apparatus for visually indicating a blast occurrence wherein the apparatus can be mounted on mobile or stationary objects or persons without requirements for rigid coupling, electrical power, sensor measurement or data processing. The apparatus comprises a base, having an upper side and a lower side; a middle layer, vertically spaced from and attachable to the upper side of the base, the middle layer having at least one opening to ambient air; and blast indication means, attachable to the middle layer. The blast indication means comprises a blast indication layer adjacent the middle layer and bonded to a housing and the blast indication layer comprises a rupturable membrane. The blast indication layer, housing, vertical spacing of the middle layer and the at least one opening in the middle layer are dimensioned so that the blast indication layer activates at or above a predetermined blast pressure and impulse to provide a visual indication of the blast occurrence.

### BRIEF DESCRIPTION OF THE DRAWINGS

These and other advantages of the invention will become apparent upon reading the following detailed description and upon referring to the drawings in which:

FIG. 1 is a side perspective view of a blast occurrence apparatus of the present application;

FIG. 2 is an exploded view of a blast occurrence apparatus;

FIG. 3 is a side view of a blast occurrence apparatus;

FIG. 4 is a perspective view of a blast occurrence apparatus showing the cover in an open position;

FIG. 5 is a side cross sectional view of a blast occurrence apparatus;

FIG. 6 is an exploded view of a blast indication device for the blast occurrence apparatus of the present application;

FIG. 7 is a top view of a blast occurrence apparatus showing the blast indication device activated;

FIG. 8 is a top view of an blast occurrence apparatus showing the blast indication device exposed to a sub-threshold blast overpressure;

FIG. 9 is a close-up cross-section view of an alternate blast indication device of the present application; and

FIG. 10 is a perspective view of a blast occurrence apparatus mounted to a standard helmet.

While the invention will be described in conjunction with the illustrated embodiments, it will be understood that it is not intended to limit the invention to such embodiments. On the contrary, it is intended to cover all alternatives, modifications and equivalents as may be included within the spirit and scope of the invention as defined by the appended claims.

### DETAILED DESCRIPTION OF THE PREFERRED EMBODIMENTS

In the following description, similar features in the drawings have been given identical reference numerals where appropriate.

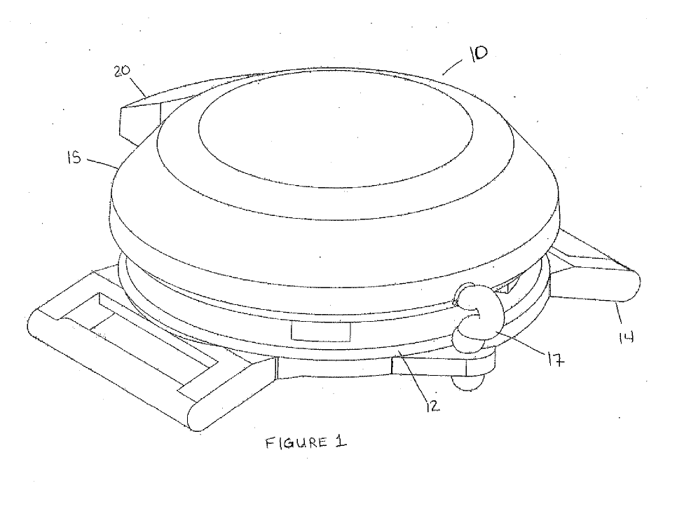

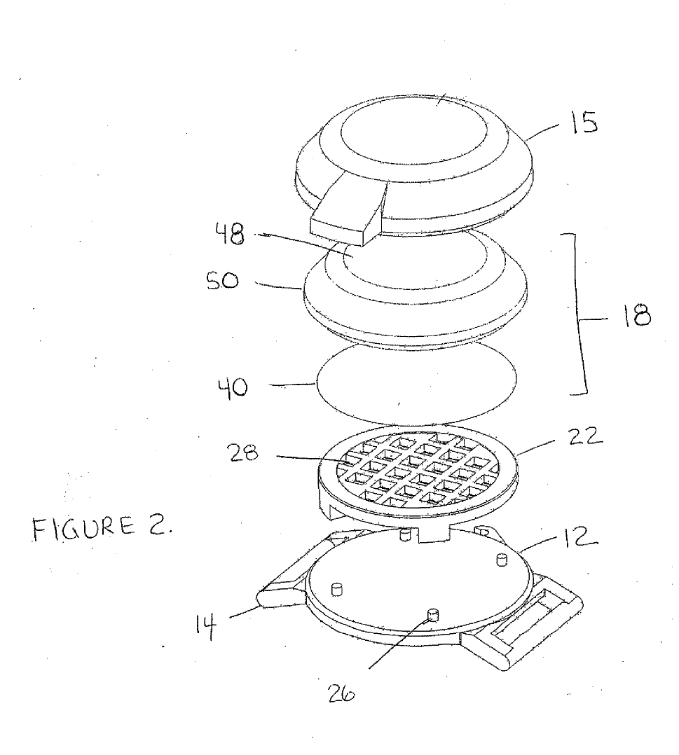

The blast occurrence apparatus 10 of the present application is shown in FIG. 1. Components of the device are shown in a broken apart view in FIG. 2. The apparatus comprises a base 12 which may be attached via mounting means 14 to a desired location for monitoring blasts. Such locations may include a military or protective helmet, clothing or other protective gear in order to monitor blasts experienced by an individual. The portable blast occurrence apparatus 10 also may be located in or on a vehicle, or the inside or outside of a building or structure as desired.

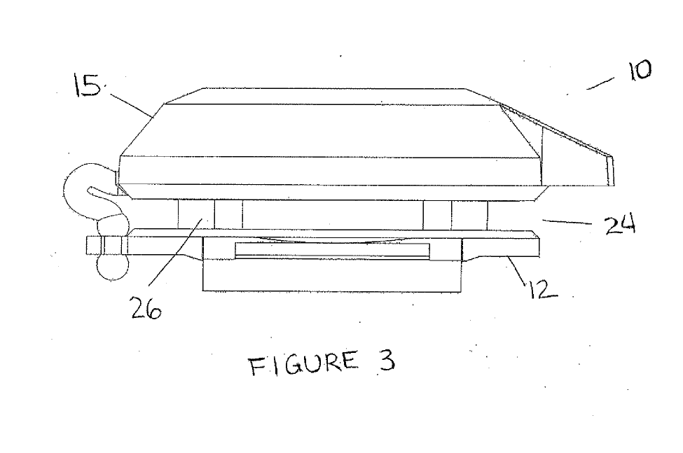

Attached to the base 12 is a cover 15 which may be permanently attached or, as shown in FIG. 1, attached via a hinge 17 or other suitable means to allow for viewing access to the interior of the apparatus. A middle layer 22 is mounted to and vertically spaced from the base 12. As seen in FIGS. 1 to 3, a vertical spacing 24 between the middle layer 22 and the base 12 is achieved via a number of mounting posts 26. The base 12, cover 15, mounting posts 26 and middle layer 22 components may be manufactured from thermoformed plastic such as PC blends, nylons, PET, PVC or other suitable material.

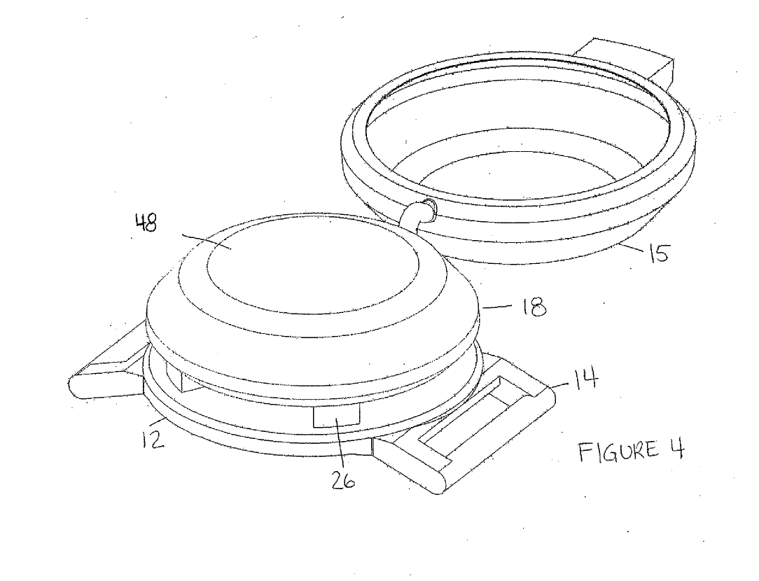

A blast indication device 18 is housed within the apparatus 10. As seen in FIGS. 2 and 4, the blast indication device 18 is located between the cover 15 and middle layer 22 and thus is raised from the base 12. The blast indication device 18 is a passive device designed to mechanically trigger on experiencing a blast at or exceeding a predetermined level of pressure and impulse, and to provide a visual indication of the occurrence of a blast, as discussed below. Cover 15 may be preferably opaque to minimize reflectivity. A closure or locking means 20 also may be provided. The status of the device can be viewed through a transparent window 48. The nature of the cover 15 and the manner in which the blast indication device 18 may be viewed will depend, in part, on the environment in which the apparatus 10 is intended for use. In some applications a cover 15 may not be required.

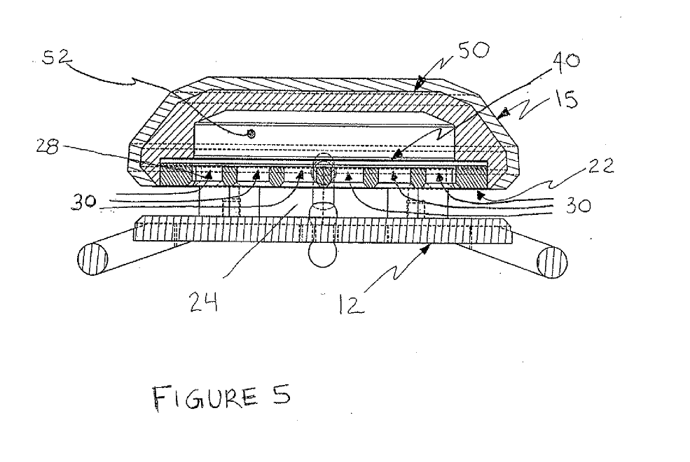

The vertical spacing 24 and openings 28 in the middle layer 22 allow for a pressure wave from a blast to enter the interior of the apparatus 10. The openings 28 allow the wave of air pressure, shown as arrows 30 in FIG. 5, to enter the apparatus 10 and exert a force on the blast indication device 18. The size of the vertical spacing 24 and openings 28 may be altered to control the blast wave entering the device so that blast indication device 18 is triggered only by a blast wave exceeding the predetermined blast overpressure level and impulse. The vertical spacing 24 may range from 1 to 10 mm. One or up to fifty openings 28 may be used with the size of openings 28 ranging from 1×1 mm square openings to an opening 35 mm in diameter. In one embodiment, the vertical spacing is 3 mm and the middle layer 22 includes twenty eight openings 28, 3.5 mm×3.5 mm in size.

It is known that bodily injury starts to occur at or around a blast overpressure of 75 kPa and that significant damage may occur at or above 350 kPa, or a range of 10 to 50 psi for unprotected soldiers. For example, a blast due to 5 kg of C4 explosive at a distance of 5.0 m will result in a peak blast overpressure of approximately 100 kPa. Thus, the dimensions of the apparatus 10 and blast indication device 18 may be adjusted to monitor a blast pressure or pulsewidth of significant level and duration. Those skilled in the art will appreciate that the exact sensitivity of biomechanical injury mechanisms will vary according to ongoing experimentation and the apparatus 10 and device 18 may be modified in size to accommodate the results of such experimentation.

The arrangement of the base 12, middle layer 22, blast indication device 18 and cover 15 protects the blast indication device 18 from accidental or deliberate puncture, direct impacts, the environment and debris such as dirt or sand. An air pressure wave resulting from a blast may enter the apparatus 10 and be directed towards the blast indication device 18 to trigger the device. Thus, the apparatus 10 and specifically the blast indication device 18 need not be directly exposed or oriented to the source of the blast and resulting air pressure wave. The blast occurrence apparatus 10 also is not limited to sensing a blast from a single direction or from a predetermined or known distance as it will trigger on the predetermined blast level if experienced by the wearer or at the location of the apparatus 10.

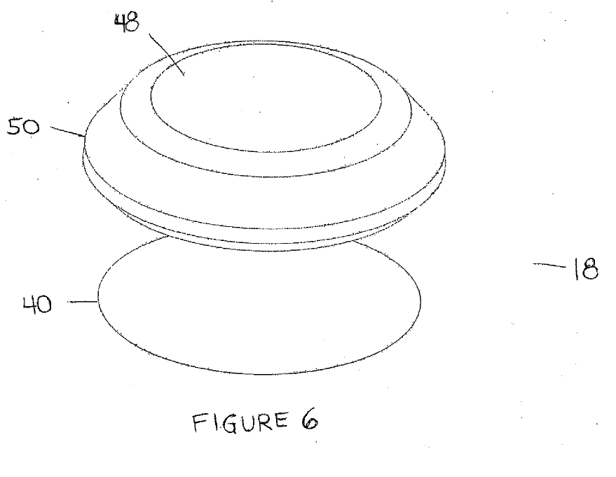

The blast indication device 18 may be comprised of passive mechanical means for indicating that a blast at or exceeding a predetermined level has been experienced by the device. In one embodiment, the blast indication device 18 may comprise a rupturable membrane 40 disposed within a housing 50, having a viewport 48, as shown in the exploded view of FIGS. 2 and 6. The rupturable membrane 40 may be manufactured from a suitable material such as aluminum and bonded to the lip of the housing 50. Other suitable materials may be used and are contemplated within the invention. Visual access to the blast indication device 18 may be achieved by removing or opening the cover 15 thus allowing for inspection of the membrane 40 though the viewport 48 in the housing 50.

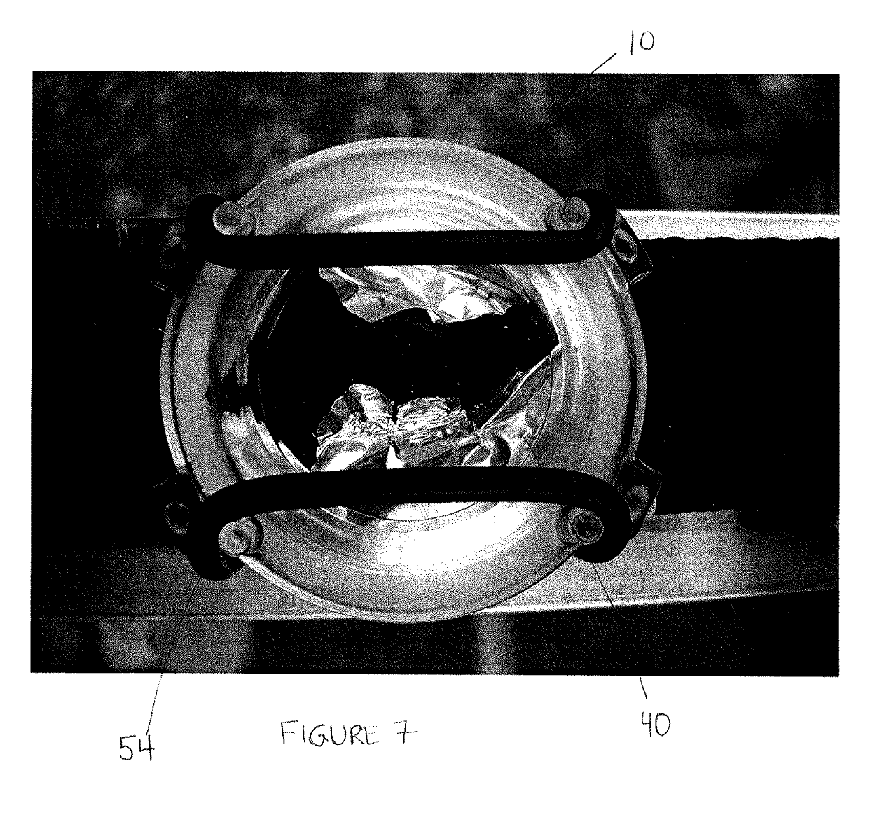

When attached to the housing 50 the membrane 40 creates a compartment 52. The size and shape of the housing 50 may be varied to vary the volume of the compartment 52 and thus vary the blast indication device 18 response to blast pressure. In one embodiment, the housing 50 has a diameter of 40 mm and height of 9 mm, providing a compartment 52 approximately 3000 mm³ in volume. In addition to viewing a tear in the membrane itself as shown in FIG. 7, a number of ways of a providing visual indication that the device has triggered may be provided. For example, the middle layer 22 may be brightly colored such that the ruptured membrane 40 may expose the brightly coloured middle layer 22. Thus, the appearance of colour indicates a significant blast of concern has occurred. FIG. 7 also illustrates alternate mounting means 54 for the blast occurrence apparatus 10.

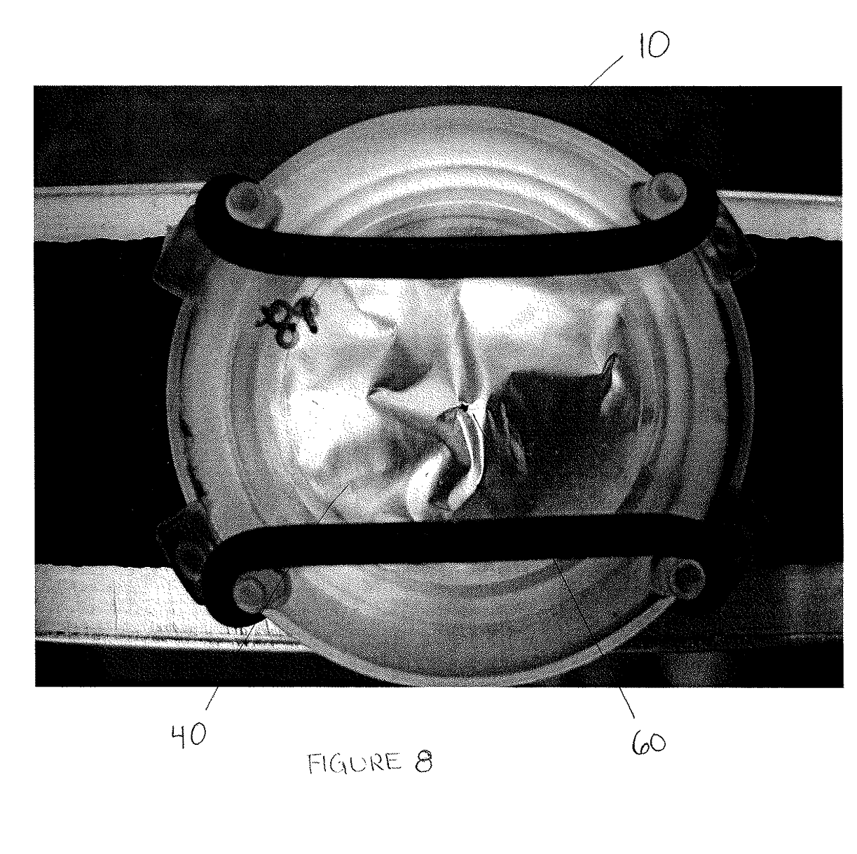

As shown in FIG. 8, the membrane 40 may be further altered to protect and to regulate the response of the membrane 40 to the blast level of interest. To tolerate changes in air pressure or temperature one or more small holes or pinholes 60 may be provided in the membrane 40 to allow for the equalization of air pressure between the compartment 52 and the ambient air pressure. Damage or preloading of the membrane 40 is thus prevented due to changes in altitude or the environment in which the apparatus 10 is used.

The pinholes 60 also act as stress risers in the membrane 40, thus the placement and number of pinholes 60 in the membrane 40 allow the blast indication device 18 to be finely tuned to react and burst at a desired pressure of interest since the pressure differential necessary to rupture the membrane 40 varies according to the size, number and placement of pinholes 60. The addition of one or more pinholes 60, preferably in the centre of the membrane 40, reduces the volume required in compartment 52 and thus allows for a smaller blast indication device 18. The method by which a pinhole 60 is fabricated also influences the failure mode of the membrane and the overpressure that would cause a rupture. Rupture of the membrane 40 may be further controlled with changes to the membrane mechanical properties. The pinholes 60 typically are introduced while introducing micro-stress risers to ensure an effect on the rupture pressure level.

Alternatively, the membrane 40 may include a cut, slit or tear (not shown), such as a straight line cut from the center of the membrane to the lip of the housing 50. A thin flexible plastic membrane 44 (not shown) may be added over the membrane 40 and housing 50 to seal the compartment 52 and create a closed volume. As the pressure near the device 18 rises, the plastic membrane 44 begins to deform inwardly towards the compartment 52. The deformed plastic membrane 44 pushes against the membrane 40 increasing the physical stress at the tip of the slit near the centre allowing the slit in the membrane 40 to propagate towards the perimeter. In this embodiment, the length of the induced slit in the membrane 40 is proportional to the applied overpressure. A pinhole (not shown) in the plastic membrane 44 may be used in this embodiment as well to allow pressure relief due to temperature fluctuations.

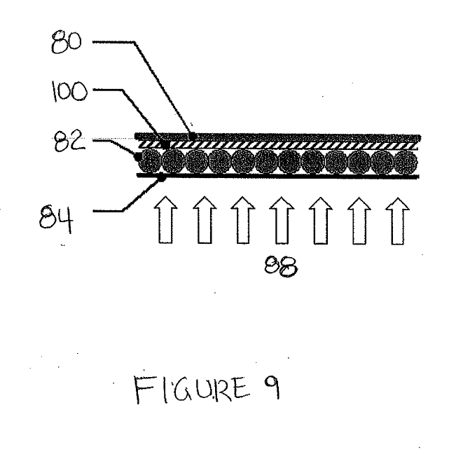

In an alternative embodiment, the blast indication device 18 may be comprised of a micro-encapsulated material, such as a microencapsulated paint disposed on a semi-rigid substrate layer 80, as shown in detail in FIG. 9. A paint containing a binder mixed with polymer microspheres 82 of liquid pigment or dye material may be used and applied to the semi-rigid substrate layer 80 such as a semi-rigid plastic layer or the housing window, and sealed by a plastic membrane 84. The microsphere diameter, wall thickness, encapsulating material and entrapped air volume are designed for activation at the predetermined blast level of interest.

In operation, pressure waves, shown as arrows 88 in FIG. 9, enter the apparatus 10 and are applied to the plastic 84 membrane covering the microspheres 82. The microspheres 82 are compressed against the substrate layer 80 and the microspheres burst, releasing the material contained in the microspheres to indicate a blast has occurred. In one embodiment, the microspheres may be 75-150 microns in diameter with a core loading (volume) of 70%-90% or alternate size and configuration as dictated by the performance and design criteria.

A further opaque blotter layer 100 may be provided between the microspheres 82 and the substrate layer 80, with the edges of the blotter layer 100, substrate layer 80 and plastic membrane 84 sealed and bonded to the lip of a blast indication device housing 50. The blotter layer 100 serves to cover the paint or dye encapsulated in the microspheres 82 and creates an uncompressible void or cavity adjacent to the microspheres 82. Upon rupture of the microspheres 82 in the paint substrate layer 80, the blotter layer 100 absorbs a portion of the released pigment or dye, providing a change in color to indicate the occurrence and exposure of the device 18 to a sufficient blast overpressure and impulse. As well, it may be appreciated that the bursting of the microspheres 82 may release a first material contained in the microspheres 82 which reacts with a second material located in the blotter layer 100 or in a second substrate layer (not shown) to provide a change in colour due to a chemical reaction.

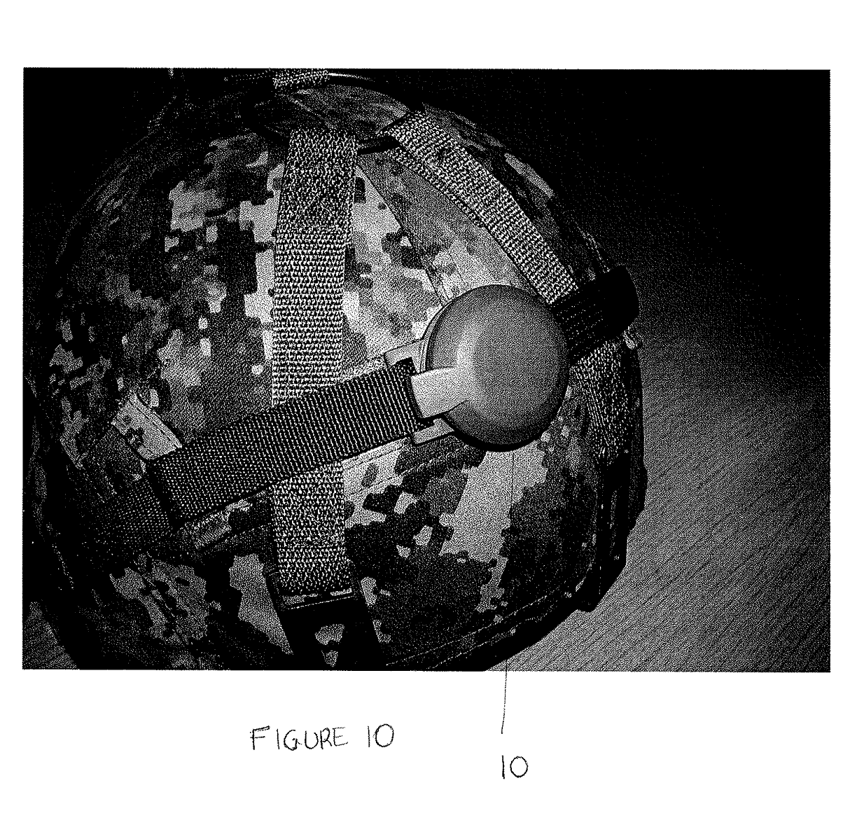

In operation, the blast occurrence apparatus 10 as described above thus will trigger to provide an indication of a harmful blast overpressure reaching the person, vehicle or structure where the device is located. The blast occurrence apparatus 10 does not trigger on acceleration or shock resulting from impacts, such as impacts which may result from dropping the device or being struck. It can be appreciated that for a small environment or individual use, a single apparatus would detect the blast pressure experienced by the individual regardless of the source or direction of the blast. The device may be worn by the individual or mounted to a helmet, as shown in FIG. 10. In a larger environment or application, one or more blast occurrence monitors 10 may be used to monitor blast pressures at different locations, such as on the sides of a building or at different points within a site to be monitored. As described above, the device 10 operates without a power source, rigid coupling, sensor measurements or data processing.

Thus, it is apparent that there has been provided in accordance with the embodiments of the present invention a blast occurrence apparatus that fully satisfies the objects, aims and advantages set forth above. While the invention has been described in conjunction with illustrated embodiments thereof, it is evident that many alternatives, modifications and variations will be apparent to those skilled in the art in light of the foregoing description. Accordingly, it is intended to embrace all such alternatives, modifications and variations as fall within the spirit and broad scope of the invention.

What is claimed is:

1. An apparatus for visually indicating a blast occurrence, said apparatus comprising:
a base, having an upper side and a lower side;
a middle layer, vertically spaced from and attachable to the upper side of the base, the middle layer having at least one opening to ambient air; and
blast indication means, attachable to the middle layer, wherein the blast indication means provides a visual indication of the blast occurrence at or above a predetermined blast pressure and impulse experienced by the apparatus.

2. The apparatus of claim 1 wherein the blast indication means comprises a blast indication layer adjacent the middle layer and bonded to a housing, forming a compartment, the blast indication layer, housing, vertical spacing of the middle layer and the at least one opening in the middle layer dimensioned so that the blast indication layer activates at or above the predetermined blast pressure and impulse.

3. The apparatus of claim 2 wherein the blast indication layer comprises a rupturable membrane.

4. The apparatus of claim 3 wherein the rupturable membrane is comprised of a layer of aluminum.

5. The apparatus of claim 3, further comprising at least one pinhole located in the rupturable membrane.

6. The apparatus of claim 5 wherein the at least one pinhole is located at a center of the rupturable membrane.

7. The apparatus of claim 3 further comprising at least one slit defined by the rupturable membrane.

8. The apparatus of claim 7 wherein the at least one slit is located at a center of the rupturable membrane.

9. The apparatus of claim 8, further comprising a flexible membrane adjacent the rupturable membrane and above the middle layer.

10. The apparatus of claim 9 wherein the flexible membrane comprises a layer of plastic.

11. The apparatus of claim 9 further comprising at least one pinhole in the flexible membrane.

12. The apparatus of claim 2 wherein the blast indication layer comprises a layer of microspheres containing a microencapsulated material released upon activation of the blast indication layer.

13. The apparatus of claim 12 wherein the microencapsulated material comprises coloured dye or pigment visible upon activation of the blast indication layer.

14. The apparatus of claim 12 further comprising an opaque blotter layer within the housing covering the blast indication layer.

15. The apparatus of claim 12 further comprising a reactive substrate layer adjacent the blast indication layer whereupon activation of the blast indication layer and release of the microencapsulated material, a reaction of the substrate layer and the microencapsulated material provides a visual blast indication.

16. The apparatus of claim 1 wherein said apparatus is configured to withstand acceleration or shock resulting from impact on the apparatus thereby reducing false activations from loads other than pressure and impulse.

17. The apparatus of claim 1 wherein said apparatus can be mounted on mobile or stationary objects or persons without requirements for rigid coupling, electrical power, sensor measurement or data processing.

18. An apparatus for visually indicating a blast occurrence, wherein said apparatus can be mounted on mobile or stationary objects or persons without requirements for rigid coupling, electrical power, sensor measurement or data processing, said apparatus comprising:
a base, having an upper side and a lower side;
a middle layer, vertically spaced from and attachable to the upper side of the base, the middle layer having at least one opening to ambient air;
blast indication means, attachable to the middle layer, said blast indication means comprising a blast indication layer adjacent the middle layer and bonded to a housing said blast indication layer comprising a rupturable membrane; and
wherein the blast indication layer, housing, vertical spacing of the middle layer and the at least one opening in the middle layer are dimensioned so that the blast indication layer activates at or above a predetermined blast pressure and impulse to provide a visual indication of the blast occurrence.

19. An apparatus for visually indicating a blast occurrence, said apparatus comprising:
a base having an upper side and a lower side;
a middle layer attached to the upper side of the base, wherein the middle layer is spaced from the upper side and includes at least one opening exposed to an ambient environment surrounding the apparatus; and
a blast indication device attached to the middle layer, wherein the blast indication device includes a housing defining a compartment and a membrane positioned generally between the compartment and the at least one opening in the middle layer, wherein the membrane is adapted to rupture upon a predetermined increase in pressure in the ambient environment.
